(19) United States
(12) Patent Application Publication
(10) Pub. No.: US 2021/0113911 A1
(43) Pub. Date: Apr. 22, 2021

(54) Tennis / Pickleball Sweatband Scorekeeper

(71) Applicant: Christopher Page Madsen, Santa Barbara, CA (US)

(72) Inventor: Christopher Page Madsen, Santa Barbara, CA (US)

(21) Appl. No.: 16/656,868

(22) Filed: Oct. 18, 2019

(51) Int. Cl. A63B 71/06; A63B 69/38; A41D 20/00

(52) U.S. Cl. CPC A63B 71/0669; G04G 9/0064; A41D 20/00; A63B 69/38

(57) ABSTRACT

An apparatus worn on the wrist of a tennis or Pickleball player for keeping score during tennis or Pickleball comprising an absorbent wrist sweatband upon which is detachably mounted (by means such as Velcro, snaps, clips etc.), in such a way as to accommodate easy, rapid removal and reattachment by hand, absent the need for tools and without the need to remove any connecting parts between the processor/display unit and the wrist sweatband, a small “watch-like” processor/display unit which, in response to points inputted by the player, displays the tennis or pickleball scores.

### BACKGROUND OF THE INVENTION

### 1) Field of the Invention

A63B71/06 “Indicating or scoring devices for games or players, or for other sports”

This invention relates to the game of tennis and or pickleball and more specifically to a device which may be worn on a player's wrist allowing the player to quickly and easily input points as they are scored and, as a result of those inputs, the processor of the device causes to be digitally displayed on the screen of the device, for quick reference by the player, the cumulative point totals for both the player and the opponent as well as the game scores for both the player and the opponent as well as the current time of day.

### 2) Discussion of Prior Art

In Tennis or pickleball a player's concentration is split between:
Scoring points and
Mentally calculating and remembering both the point scores during a game for both players as well as the game point totals within a set for both players.

### Problem

It is a routine and everyday occurrence during the playing of the game of tennis or pickleball that players have to interrupt play because there is question or disagreement as to what the score is. Accordingly, having to mentally keep score during a tennis or pickleball game is stressful and distracting from the main focus of the physical competition.

### Solution

The objective of this invention is to provide a player a portable, wearable device which will cumulatively calculate and keep tally of the points scored in a game by both players as well as the number of games won within a set by both players, thus allowing the player to focus on the physical competition rather than the mental calculation and memorization of scores. What distinguishes this invention from prior art is that:
1) The invention of this patent application is worn on the wrist and is a combination wrist sweatband/score keeping device. Prior art includes several devices for keeping score in tennis that are secured to the wrist by means of a band that opens and then buckles closed around the wrist, similar to a watch band. (U.S. Pat. Nos. 3,122,851, 3,936,963, Patent US 2013/0,192,514 A1, U.S. Pat. Nos. 6,634,548 B1, 5,898,751). There are several problems with this type of design:
   a) Many Tennis or pickleball players simply do not like the feel of a plastic or other standard style band on their wrist when playing tennis or pickleball. The buckle can push into and leave depressions in the skin. Sweat can accumulate under the band. The band tends to slide back and forth across the wrist. The invention of this patent application secures around the wrist by means of a soft, absorbent, elastic sweatband which fits snuggly and comfortably on the wrist, thus eliminating this displeasures and discomforts caused in prior art.
   b) It is difficult and time consuming to secure the buckle-type band around the wrist. The invention of this patent application, being a continuous band with no openings or buckles, and being of an elastic composition, slides over the hand and onto the wrist quickly and comfortably. The speed and ease of use in putting on the Invention of this patent application is a significant improvement over prior art.
   c) Because the buckle on watchband-like score keepers of prior art are designed to be worn with the processing/display unit on the top of the wrist, access to the processing/display unit requires an uncomfortable amount of rotation of the forearm making it awkward and difficult to navigate and operate their input buttons, as well as to view their screen. The invention of this patent application is worn in such a way that the processor/display unit is located on the underside of the wrist. From this position, minimal rotation of the forearm is required making operation of the input buttons much easier as well as making screen viewing much easier.
   d) Many tennis or pickleball players wear a wrist sweat band (for wiping sweat from their face) usually on the wrist opposite from their racket hand. This is typically the same wrist that person would wear a watch on or, in this case, a score keeping device (right handed person would hold racket in right hand and wear watch and or wrist sweatband on left wrist). Obviously it would be too bulky and uncomfortable to try to wear both a wrist sweatband and a watchband-like score keeper (as in prior art) at the same time on the same wrist. And, if undertaken, having a watchband-like score keeper (as in prior art) on the upper side of the wrist would cause it to be in close proximity to the wrist sweatband and would greatly interfere with utilizing the wrist sweatband to wipe sweat from the player's face. The invention of this patent application solves the problem by combining a score keeping processor/display unit with a wrist sweatband, and in such a way that the processor/display unit is positioned entirely on the underside of the wrist. With this under wrist arrangement, 100% of the top of the wrist sweatband (the side normally used for wiping sweat from the face) is free of any attached objects and 100% available for wiping sweat from the player's face. No prior art has engineered such a combination of a wrist sweatband and a tennis or pickleball score keeping device.
2) The processor/display unit of the invention of this patent application is detachably mounted to the wrist sweatband in such a way that it can be removed rapidly and absent the need for tools or the need to remove any parts connecting the processor/display unit to the wrist sweatband. This gives the player the ability to quickly and easily remove the processor/display unit from the wrist sweat band so that:
   a) The player can wash a soiled wrist sweatband absent the processor/display unit (to avoid damaging the processor/display unit).
   b) The player can quickly remove the processor/display unit from a soiled wrist sweatband and attach it to a clean one before resuming play.
   c) The player can quickly remove the processor/display unit from the wrist sweatband and attach it to a wrist sweatband of a different color or size. There is no prior art in which a tennis or pickleball score keeping processor/display unit can be removed rapidly from a wrist band, absent the need for tools or the need to remove any parts connecting the processor/display unit to the wrist
3) The invention of this patent application is designed to be very intuitive and user friendly, such that there is little or no need for instructions. This is a notable improvement over prior art in which a careful study of instructions is required in order to understand the various functions as well as to facilitate identification of the various unlabeled buttons and digital numbers that litter the housing and screen. (Patent US 2013/0192514 A1, U.S. Pat. Nos. 3,122,851, 3,936,963, 6,634,548 B1, 5,898,751). With the invention of this patent every button and the every field for digital display is labeled in simple, intuitive language such as:
   Buttons:
      On (hold)
      Off (hold)
      My Point
      Their Point
      Hours
      Minutes
      Undo Entry
      Reset
   Digital Display Fields:
      My Score
      Their Score
      My Games
      Their Games
4) The invention of this patent application displays the current time and all four scores as follows:
   Player's point score
   Opponent's point score
   Player's game score
   Opponent's game score
      on the device screen at the same time allowing the player a split second snapshot of all scores. This speedy snapshot is essential during an active game. Prior art, such as patent US 2013/0192514 A1, either does not provide all of this information or requires scrolling through different screens to view all this information bit by bit, which is completely impractical during an active game. The ability to get a speedy snapshot view of ALL scores as provided by the Invention of this patent application is a notable improvement over prior art.
5) The invention of this patent application is designed specifically and solely for the purpose of keeping score in the game of TENNIS (one model for just tennis) or Pickleball (one model for just pickleball). Other wrist worn Score Keeping devices of prior art, such as patent US 2013/0192514 A1, contain programs for keeping score in more than one sport on one device, which requires a player to first navigate through the different programs and set the device up for their sport according to often times confusing directions. The invention of this patent application, with the push of a single button, is ready to immediately begin scoring a tennis or pickleball game, and is so intuitive it should require no instructions, making it a notable improvement over prior art.
6) The invention of this patent application is intended to be a very user friendly, intuitive design requiring minimal input. Input requirements from a player involve no more than depressing one of two buttons as a point is scored; one button as the player scores a point or an alternate button as the opponent scores a point. This ease of use is imperative so as to avoid distraction during an active, demanding game which requires the full attention of the player. Methods of recording points and scores in prior art are more complicated, cumbersome and confusing and, in general, distracting to the game.
7) The buttons of the invention of this patent application used for inputting scored points are notably oversized, such as a keyboard button, allowing for quick, easy, error free entry during an active, quick moving game. Buttons in prior art are so small as to be difficult to depress quickly and properly without causing error or distraction to the player in the middle of an active game.

### SUMMARY OF THE INVENTION

An apparatus worn on the wrist of a tennis or pickleball player for keeping score during tennis or pickleball comprising an absorbent wrist sweatband upon which is detachably mounted (by means such as Velcro, snaps, clips etc.), in such a way as to accommodate easy, rapid removal and reattachment, a small “watch-like” processor/display unit which displays the tennis or pickleball scores.

The wrist sweatband, by means of elastic construction, is stretched by the player and slipped over the player's hand onto the player's wrist. When released, the elasticity causes the wrist sweatband to constrict and fit snuggly on the player's wrist. The wrist sweatband is positioned on the wrist such that the processor/display unit is positioned on the underside of the wrist for maximum ease of access, and such that the portion of the wrist sweatband on the top of the wrist is clear of any attached objects and 100% free and available for wiping sweat from the player's face.

The player records points as they are scored during the tennis or pickleball games by pushing input buttons on the processor/display unit causing the processor/display unit to display the game and set scores, in accordance with standard tennis and pickleball scoring format, on the screen of the processor/display unit.

The processor causes to be displayed on the screen of the processor/display unit at the same time, all four relevant scores as follows:
Player's point score
Opponent's point score
Player's game score
Opponent's game score
   allowing the player a split second snapshot of all scores. This speedy snapshot is essential during an active game.

The ability to rapidly remove and reattach the processor/display unit from the wrist sweatband by hand, absent the need for tools or the need to remove any connecting parts, facilitates quick, easy removal of the processor/display unit for intra game replacement of a soiled wrist sweatband or a preferential exchange of the processor/display unit to a wristband of a different size or color or for post-game washing of the wrist sweatband (absent the processor/display unit).

### DESCRIPTION OF THE DRAWINGS

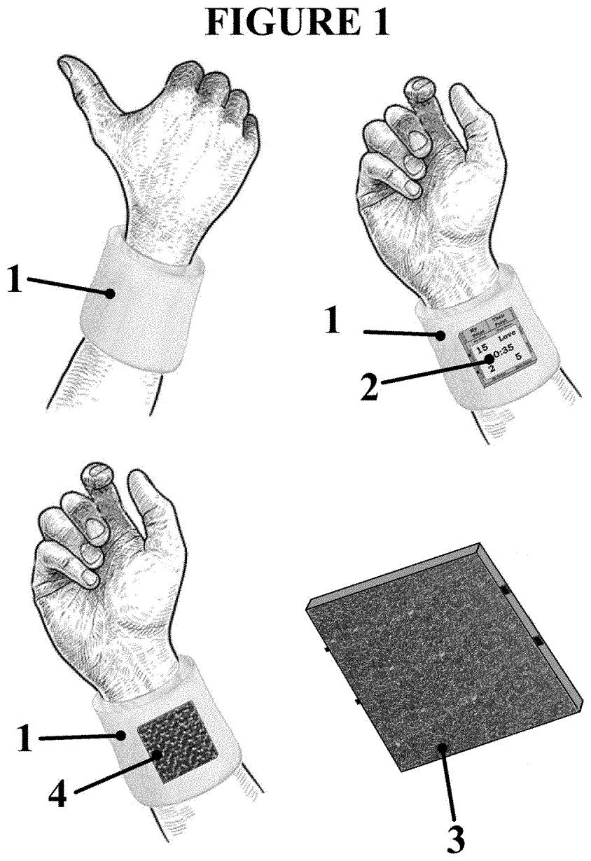

FIG. 1
1) Wrist Sweatband
2) Processor/display unit
3) Material or device for detachable mounting affixed to back of processor/display unit
4) Material or device for detachable mounting affixed to a portion of the Wrist Sweatband

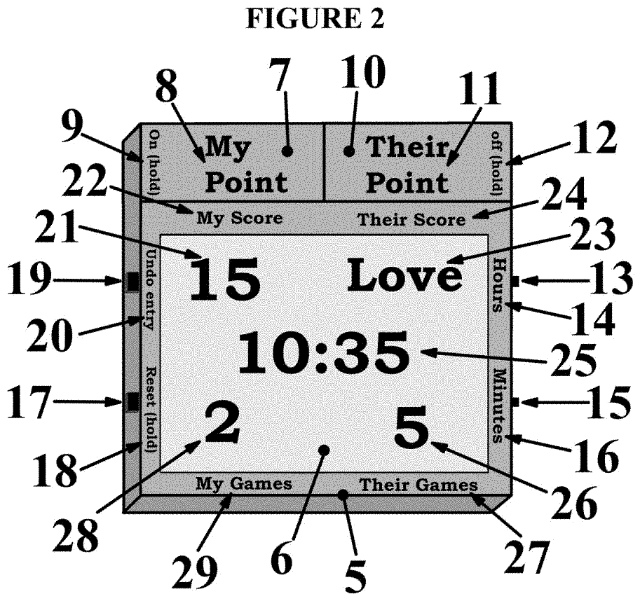

FIG. 2
5) Processor/display unit body
6) Processor/display unit screen
7) “Player's Point” input button/“On” button (“On” with prolonged depression)
8) “Player's Point” button identifying label such as “My Point”
9) “On” button identifying label such as “On (hold)”
10) “Opponent's Point” input button/“Off” button (“Off′ with prolonged depression)
11) Opponent's Point” button identifying label such as “Their Point”
12) “Off” button identifying label such as “Off (hold)”
13) Time set “Hours” button
14) “Hours” button identifying label such as “Hours”
15) Time set “Minutes” button
16) “Minutes” button identifying label such as “Minutes”
17) “Reset” button
18) “Reset” button identifying label such as “Reset”
19) “Undo Entry” button
20) “Undo Entry” button identifying label such as “Undo Entry”
21) Screen area for display of “Player's Points”
22) “Player's Point” digital display identifying label such as “My Score”
23) Screen area for display of “Opponent's Points”
24) “Opponent's Points” digital display identifying label such as “Their Score”
25) Screen area for display of “Time of day”
26) Screen area for display of “Opponent's Game Score”
27) “Opponent's Game Score” digital display identifying label such as “Their Games”
28) Screen area for display of “Player's Game score”
29) “Player's Game Score” digital display identifying label such as “My Games”

### DETAILED DESCRIPTION OF THE INVENTION

FIG. 1
1) #1 Illustrates the wrist sweatband (1) which fits snuggly on a player's wrist and to which is detachably attached the processor/display unit (2). The wrist sweatband (1), is a continuous, closed loop which a tennis or pickleball player may, as facilitated by its elastic nature, stretch and slide over the hand. The wrist sweatband (1) is then positioned on the player's wrist such that the processor/display unit (2) is positioned on the underside of the wrist.
2) #2 Illustrates the processor/display unit (2) which detachably attaches to the wrist sweatband (1) (by means such as Velcro, snaps, clip etc.) in such a way as to accommodate easy, rapid removal and reattachment of the processor/display (2) unit from the wrist sweatband (1) by hand, without the use of tools and without the need to remove any connecting parts between the processor/display unit (2) and the wrist sweatband (1). The processor/display unit (2) comprises a watch-like body (5), a screen (6) which displays digital numbers and characters, a processor which processes the player's inputs and displays the computed tennis or pickleball scores on the screen (6), a battery to power the processor, and several buttons which the player may use to input information.
3) #3 illustrates a Material or device for detachable mounting (3) (such as Velcor, snaps or clip etc.) which is an integral, non-removable component of the back side (opposite from screen side) of the processor/display unit (2), and which is capable of “mating” with a material or device of like design. The companion mating component is permanently affixed to a portion of the wrist sweatband (1) such that the processor/display unit (2) can be rapidly attached and removed from the wrist sweatband by hand (1), without the use of tools and without the need to remove any connecting parts between the processor/display unit (2) and the wrist sweatband (1).
4) #4 illustrates a Material or device for detachable mounting (4) (such as Velcor, snaps or clip etc.) which is an integral, non-removable component of a portion of the wrist sweatband (1), and which is capable of “mating” with the material or device of like design (as described in 3 above) which is permanently affixed to the back side (opposite from screen side) of the processor/display unit (2), such that the processor/display unit (2) can be rapidly attached and removed from the wrist sweatband (1) by hand, without the use of tools and without the need to remove any connecting parts between the processor/display unit (2) and the wrist sweatband (1).

FIG. 2
5) #5 illustrates the processor/display unit BODY (5). The processor/display unit body (2) accommodates input buttons and assigned areas of screen space for data display; all of which have identifying labels imprinted on the body such as:
   On (hold) (9)
   Off (hold) (12)
   My Point (Player's point) (8)
   Their Point (Opponent's point) (11)
   My Games (Player's game score in set) (29)
   Their Games (Opponent's game score in set) (27)
   Reset (18)
   Undo Entry (20)
   Hours (14)
   Minutes (16)

Contained, as integral moving parts of the body are input buttons for:
Player's Point (which doubles as an “On” button when momentarily held in a depressed position) (7)
Opponent's Point (which doubles as an “Off” button when momentarily held in a depressed position) (10)
Reset (17)
Undo Entry (19)
Hours (13)
Minutes (15)
6) #6 illustrates the Processor/display unit SCREEN (6). The processor/display unit screen (6) displays five pieces of data such as
the space in the middle of the screen is allocated for the time of day, (25)
the upper left for the player's point score in the current game, (21)
the upper right for the opponent's point score in the current game, (23)
the lower right for the opponent's game score in the current set, (26)
lower left for the player's game score in the current set. (28)
7) #7 illustrates the “Player's Point” input button/“On” button (7) primarily for inputting a point scored by the player. As soon as a the player scores a point he pushes this button and the processor recalculates his score and digitally displays his current score on the screen. The button is notably oversized such as a keyboard key, to make inputting easy and error free during an active game. This button also doubles as an “On” button. If, when the processor/display unit (2) is in “hibernate” mode, this button is held in the depressed position for approximately 3 seconds the device will turn on.
8) #8 illustrates the “Player's Point” button identifying label (8) which is printed on the ““Player's Point” input button/“On” Button”” (7) such as “My Point” (8).
9) #9 illustrates the “On” button identifying label (9) which is printed on the ““Player's Point” input button/“On” Button”” (7) such as “On (hold)” (9)
10) #10 illustrates the “Opponent's Point” input button/“Off” button (10) primarily for inputting a point scored by the opponent. As soon as the opponent scores a point the player pushes this button and the processor recalculates the opponent's score and digitally displays his current score on the screen. The button is notably oversized such as a keyboard key, to make inputting easy and error free during an active game. This button also doubles as an “Off′ button. If, when the processor/display unit is in “On” mode, this button is held in the depressed position for approximately 3 seconds the device will turn off.
11) #11 illustrates the “Opponent's Point” button identifying label (11) which is printed on the ““Opponent's Point” input button/“On” Button”” (10) such as “Their Point” (11).
12) #12 illustrates the “Off” button identifying label (12) which is printed on the ““Opponent's Point” input button/“On” Button”” (10) such as “Off (hold)” (12)
13) #13 identifies the Time set “Hours” button (13) which is used to adjust the hours of the current time of day. Each time the button is pressed the hour advances by 1.
14) #14 identifies the Time set “Hours” button label (14) which is printed on the body of the processor/display unit (2) next to the ‘Time set “Hours” button’ (13) such as “Hours” (14)
15)#15 identifies the Time set “Minutes” button (15) which is used to adjust the minutes of the current time of day. Each time the button is pressed the minutes advance by 1.
16) #16 identifies the “Minutes” button identifying label (16) which is printed on the body of the processor/display unit (2) next to the ‘Time set “minutes” button’ (15) such as “Minutes” (16)
17) #17 identifies the “Reset” button (17) which, when depressed, causes the processor to reset all scores, as displayed on the processor/display unit screen (6), to zero for the start of a new game and set.
18) #18 identifies the “Reset” button identifying label (18) which is printed on the body of the processor/display (2) unit next to the Reset button 17) such as “Reset” (18).
19) #19 identifies the “Undo Entry” button (19) which, when depressed, deletes the last point that was inputted and returns the display to the score displayed prior to that entry. This in the event that a player realizes he pushed the wrong player's point input button.
20) #20 identifies the “Undo Entry” button identifying label (20) which is printed on the body of the processor/display unit (2) next to the Undo Entry button (19) such as “Undo Entry” (20).
21) #21 identifies the Screen area for display of “Player's Points” (21). This is where the computed total of the points inputted for the Player's points within a game, is digitally displayed, according to standard tennis or pickleball scoring format.
22) #22 identifies the “Player's Point” digital display identifying label (22) which is printed on the body of the processor/display unit (2) next to the screen area for display of Player's Points (21) such as “My Point” (22)
23) #23 identifies the Screen area for display of “Opponent's Points” (23). This is where the computed total of the points inputted for the Opponent's points within a game, is digitally displayed, according to standard tennis or pickleball scoring format.
24) #24 identifies the “Opponent's Points” digital display identifying label (24) which is printed on the body of the processor/display unit (2) next to the screen area for display Opponent's Points (23) such as “Their Point” (24)
25) #25 identifies the Screen area for display of “Time of day” (25). This is where the hours and minutes of the current time of day, as inputted by the player, are digitally displayed.
26) #26 identifies the Screen area for display of “Opponent's Game Score” (26) This is where the computed total of the games won by the opponent during the set is digitally displayed. Each time a game is won by a player the Player's Point Score and the Opponent's Point Score reset to zero, and the Game Score of the player who won that last game is increased by 1.
27) #27 identifies the “Opponent's Game Score” digital display identifying label (27) which is printed on the body of the processor/display unit (2) next to the screen area for display the Opponent's Game Score (26) such as “Their Games” (27)
28) #28 identifies the Screen area for display of “Player's Game score” (28). This is where the computed total of the games won by the Player during the set is digitally displayed. Each time a game is won by a player the Player's Point Score and the Opponent's Point Score reset to zero, and the Game Score of the player who won that last game is increased by 1.
29) #29 identifies the “Player's Game Score” digital display identifying label (29) which is printed on the body of the processor/display unit (2) next to the screen area for display the Player's Game Score (28) such as “My Games” (29)

I claim:

1) An apparatus worn on the wrist of a tennis or pickleball player for keeping score during tennis or pickleball comprising a small “watch-like” processor/display unit which digitally displays the scores in response to the player depressing appropriate input buttons, said processor/display unit being detachably mounted on an absorbent wrist sweatband in such a way as to accommodate easy, rapid removal and reattachment of said processor/display unit from said wrist sweatband by hand, without the use of tools and without the need to remove any connecting parts between said processor/display unit and said wrist sweatband.

2) The apparatus of claim 1, wherein said processor/display unit is mounted to said wrist sweatband in such a way (such as Velcro, snaps, clips etc.) that it may be removed from said wrist sweatband rapidly and easily without the use of tools.

3) The apparatus of claim 1, wherein said processor/display unit is mounted to said wrist sweatband with an absence of any removable connecting parts (such as pins etc.,) that would require removal prior to removal of said processor/display unit from said wrist sweatband.

4) The apparatus of claim 1, wherein said wrist sweatband, by nature of its elastic character, can be slipped over a player's hand and onto the player's wrist absent the need to unbuckle and then buckle, or, by any other means, open and then close said wrist sweatband.

5) The apparatus of claim 1, wherein said wrist sweatband has, as a permanently attached component, a mechanism (such as Velcro, snaps, clip etc.) for facilitating the rapid attachment and detachment of said processor/display unit from said sweat wristband.

6) The apparatus of claim 1, wherein said apparatus is positioned on the wrist such that said processor/display unit is positioned on the underside of the wrist, and the portion of said wrist sweatband on the upper side of the wrist is 100% free of attached objects, thus 100% available for wiping sweat from the face of the player; this in contrast to conventional watches or wrist score keeper devices that position the processor display unit on the top of the wrist.

7) The apparatus of claim 1, wherein said processor/display unit comprises:
a) A body comprising:
a top surface
a bottom surface
Enclosed siding such as a continuous side (such as a circle) or multiple sides (such as a square, pentagon etc.) the height of said siding being proportionally smaller relative to the diameter or width of said top and bottom surfaces, such that, the overall shape of said body resembles that of a watch body.
b) A screen on said top surface of said body which displays numbers and letters digitally to indicate scores and time of day.
c) A large button for inputting the player's points and a large button for inputting the opponents point.
d) A button for undoing the last point entry, thus reverting the display to the previous score
e) A button for resetting the displayed point and game scores to zero.
f) A button for setting the current time of day, hour on the time display
g) A button for setting the current time of day, minutes on the time display

8) The processor/display unit of claim 6, wherein said bottom surface of said processor/display unit has, as a permanently attached component, a mechanism (such as Velcro, snaps, clip etc.) for facilitating rapid attachment and detachment of said processor/display unit from said sweat wristband.

9) The processor/display unit of claim 6, wherein, in response to the player pushing said point input buttons, said processor causes to be displayed on said screen of said processor/display unit:
a) the players point score in the current game, in accordance with standard tennis or pickleball scoring format
b) the opponents point score in the current game, in accordance with standard tennis or pickleball scoring format
c) the players game score in the set, in accordance with standard tennis or pickleball scoring format
as well as
d) the opponents game score in the set, in accordance with standard tennis or pickleball scoring format
all simultaneously on said screen at the same time

10) The processor/display unit of claim 6, wherein, once the final point of a game has been scored and inputted into said processor/display unit by the player, said processor causes the displayed point scores to reset to zero, and causes the displayed game score of the player who won the game to increase by 1 game.

11) The processor/display unit of claim 6, wherein said button for inputting the player's points and said button for inputting the opponent's points are notably oversized (for ease of use) and are clearly labeled with identifiers such as “My Point” & “Their Point” or “Player point” & “Opponent Point” etc. Said buttons approximately equaling the size of a fingertip or larger.

12) The processor/display unit of claim 6, wherein a component of said processor/display unit is a button which, when depressed, causes said processor to undo the last input for a player's point score thus causing the score that is digitally displayed on said processor/display unit to revert to what was displayed prior to the last inputted entry of a player's point score. Said button clearly labeled with an identifier such as “Undo”.

13) The processor/display unit of claim 6, wherein a component of said processor/display unit is a button which, when depressed and held down for a few seconds causes all scores displayed on said processor/display unit screen to reset to zero. Said button clearly labeled with an identifier such as “Reset”.

14) The processor/display unit of claim 6, wherein, said processor causes to be displayed digitally, on said screen of said processor/display unit, alongside the
a) Player point score
b) Opponent point score
c) Player game score
d) Opponent game score,
the current time of day.

15) The processor/display unit of claim 6, wherein, a component of said processor/display unit is a button which, when depressed, each consecutive push of said button causes said processor to advance the digital display of the hour component of said current time of day displayed on said screen of said processor/display unit by a factor of 1. Said button being clearly labeled with an identifier such as “Hour”.

16) The processor/display unit of claim 6, wherein, a component of said processor/display unit is a button which, when depressed, each consecutive push of said button causes the processor to advance the digital display of the minutes component of said current time of day displayed on the screen of said processor/display unit by a factor of 1. Said button being clearly labeled with an identifier such as “Minutes”.

17) The processor/display unit of claim 6, wherein, said processor/display unit is turned on by depressing and holding in the depressed position for a prolonged period, such as 3 seconds, said button used to input the player's points, this function being logically labeled on or near said button with an identifier such as “On (hold)”, and said processor/display unit is turned off by depressing and holding in the depressed position for a prolonged period, such as 3 seconds, said button used to input the opponents points, this function being logically labeled on or near said button with an identifier such as “Off (hold)”.

18) The processor/display unit of claim 6, wherein, after a prolonged period, such as 30 minutes, of inactivity with no buttons on said processor/display unit being pushed, said processor/display unit will automatically go into hibernation mode and said screen will go blank, causing the battery to conserve power.
